(19) United States
(12) Patent Application Publication
(10) Pub. No.: US 2017/0149810 A1
(43) Pub. Date: May 25, 2017

(54) MALWARE DETECTION ON WEB PROXY LOG DATA

(71) Applicant: Hewlett Packard Enterprise Development LP, Houston, TX (US)

(72) Inventors: Renato Keshet, Haifa (IL); Justin Scaggs, Plano, TX (US); Yaniv Sabo, Haifa (IL); Ron Maurer, Haifa (IL); Hila Nachlieli, Haifa (IL); Alina Maor, Haifa (IL); Olga Shain, Haifa (IL); Alexander Maydanik, Yokneam Ilit (IL)

(21) Appl. No.: 14/951,807

(22) Filed: Nov. 25, 2015

(51) Int. Cl. H04L 29/06

(52) U.S. Cl. CPC H04L 63/1425; H04L 63/0263; H04L 63/0245; H04L 63/145; H04L 63/0281

(57) ABSTRACT

An interactive system to detect malware is provided to interactively analyze web proxy log data. The log data is progressively processed to compute analytics for different context settings. The system has a context module, an interaction module and a plurality of analytics modules. When a change of the context setting (filter, weights etc.) is requested, the processing and calculation of analytics for the current context setting is paused and subsequently restarted for the now changed context setting. An analytics interface provided via a graphical user interface is updated upon the change of context settings.

### BACKGROUND

Malware on computers which are located in a network may be detected by interactive analysis of log files recording Internet traffic of the computers. The analytics tasks may include visualization of traffic types, filters and grouping as well as data aggregation and correlation analyses on the basis of log file data.

### BRIEF DESCRIPTION OF THE DRAWINGS

FIG. 1 schematically illustrates an example of a connection of a local area network (LAN) of several computers to the Internet via a web proxy in accordance with an implementation of the present disclosure.

FIG. 2 schematically illustrates an example Transmission Control Protocol (“TCP”) packet containing an HTTP request encapsulated in an IP packet for transporting the HTTP request to the Internet in accordance with an implementation of the present disclosure.

FIG. 3 is an example schematic block diagram illustrating a system for interactive analysis of web proxy log data to detect malware capable of providing different context settings for the analysis in accordance with an implementation of the present disclosure.

FIG. 4 is an example schematic block diagram illustrating analytics modules provided in the system in accordance with an implementation of the present disclosure.

FIG. 5 is an example schematic block diagram of the system processing a request to change weights of features of web proxy log data in computing analytics for a context setting in accordance with an implementation of the present disclosure.

FIG. 6 is an example schematic block diagram of a particular analytics module, namely a clustering module in accordance with an implementation of the present disclosure.

FIG. 7 is an example schematic block diagram of the system processing a request to focus on web proxy log data originating from specific IP addresses in accordance with an implementation of the present disclosure.

FIG. 8 is an example schematic block diagram of the system processing a request to create a filter for tracking a specific behavior in accordance with an implementation of the present disclosure.

FIG. 9 is an example schematic block diagram of the system processing a request to focus on a specific anomaly in accordance with an implementation of the present disclosure.

FIG. 10 is an example schematic block diagram of the system processing a selection of a cluster or a correlation displayed on a graphical user interface (GUI) in accordance with an implementation of the present disclosure.

FIG. 11 is an example schematic block diagram of the system processing a selection of a particular group of computers or a selection of log data with suspicious attribute values in accordance with an implementation of the present disclosure.

FIG. 12 is an example flow diagram illustrating a method of interactively analyzing web proxy log data for malware detection using different context settings in accordance with an implementation of the present disclosure.

FIG. 13 is an example flow chart illustrating the method, wherein a request for increasing the weight of particular features in computing analytics for a context setting is processed in accordance with an implementation of the present disclosure.

FIG. 14 is an example flow chart illustrating the method, wherein a request for clustering web proxy log data according to a geographical distance of IP addresses and to merge and to split the created clusters is processed in accordance with an implementation of the present disclosure.

FIG. 15 is an example flow chart illustrating exemplary activities of a subject matter expert when inspecting correlations after having applied a filter on the web proxy log data in accordance with an implementation of the present disclosure.

FIG. 16 is an example flow chart illustrating exemplary activities of a subject matter expert when inspecting top anomalies in accordance with an implementation of the present disclosure.

FIG. 17 illustrates an example computer system running the system for interactive analysis of web proxy log data to detect malware in accordance with an implementation of the present disclosure.

### DETAILED DESCRIPTION

In a typical Security Operations Center, IT events are screened by a matching system (such as HP ArcSight's ESM) in the search for security issues such as malware traffic. The screening is usually performed by checking each event against a set of pre-defined signatures. Once correlated against one of the signatures, an event is moved to a queue, which is accessed by subject matter experts (SME's) such as security analysts. An SME will investigate each correlated event in the queue, and determine whether the event is indeed related to a security issue (and take the steps required to solve it) or not. The screening signatures are usually hand-crafted by SME's, who manually input them into the matching system. However, it is not enough to fix a set of signatures. The nature of cyber-crime is such that new or modified malware is created every day by hackers, and therefore there is a need for constantly maintaining and updating the set of signatures. For that end, an SME has to look for unknown issues, and this is done by “hunting” for anomalous events in the whole event stream. Once the SME detects an anomaly and determines that it relates to a security issue, they design a new signature to address it, There is a need and opportunity for using analytics to enable the “hunter” to find more unknown issues, more rapidly.

Generally, the system described herein does not aim for an analytics automation; instead the system may continually interact with the SME, and may rely on the SME, to steer the system to select a suite of analytics capabilities that may be relevant to the SME. As described herein, a computer implemented system is disclosed that accesses web proxy log data and a collection of analytics modules to iteratively provide a sequence of interactive analytics interfaces that are respectively based on selections of data characteristics, and/or results of data analytics. Generally, the term “analytics interface” as used herein, describes a user interface for visual representation of results of analytics algorithms. For example, the analytics interface may provide a visual representation of analyzed data, including any identified anomalous events. As another example, the analytics interface may provide a visual representation of clusters of data based on a suitable similarity. In some examples, such visualizations may be progressive (e.g., continually updated as more data is received and/or analyzed).

As described in various examples herein, interactive analytics interfaces based on context modifications are disclosed. One example is a system including a context module and an interaction module. The context module accesses a collection of analytics modules progressively processing the web proxy log data to compute web proxy log analytics for a first context setting and to generate a first analytics interface based on the first context setting indicative of a plurality of parameters of web proxy log data. Web proxy log analytics may be the results of analytic methods applied to the web proxy log data, the results being displayed by histograms, diagrams, charts, scatter plots or the like. A context setting may be a set of features characterizing an interactive analytics interface (presentation of data, buttons, objects to be selected, etc.) with regard to specific analytical methods applied to the web proxy log data. The interaction module provides the first analytics interface to a computing device via a graphical user interface, identifies a requested change in the first context setting via an interaction with the graphical user interface, and prompts the context module to pause generation of the first analytics interface and the analytics modules to pause computing analytics in response to the requested change. The context module modifies the first context setting based on the requested change to create a second context setting, and generates a second analytics interface responsive to the second context setting. Progressively processing of the web proxy log data is restarted to compute web proxy log analytics for the second context setting upon creation of the second context setting.

In the following detailed description, reference is made to the accompanying drawings which form a part thereof, and which show by way of illustration specific examples in which the disclosure may be practiced. It is to be understood that other examples may be utilized, and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

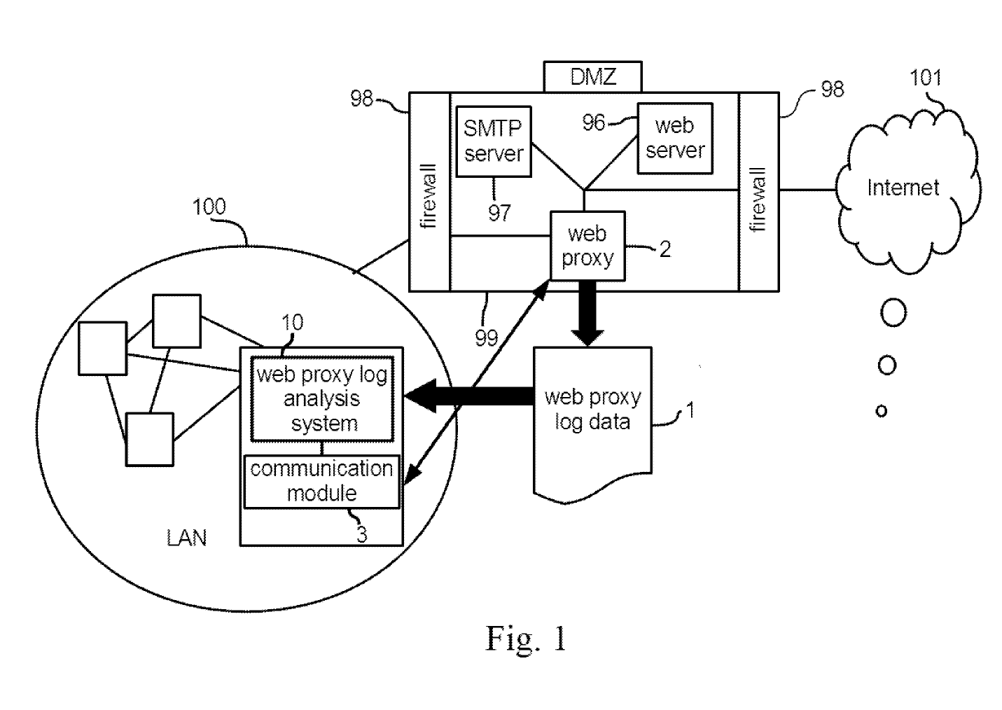

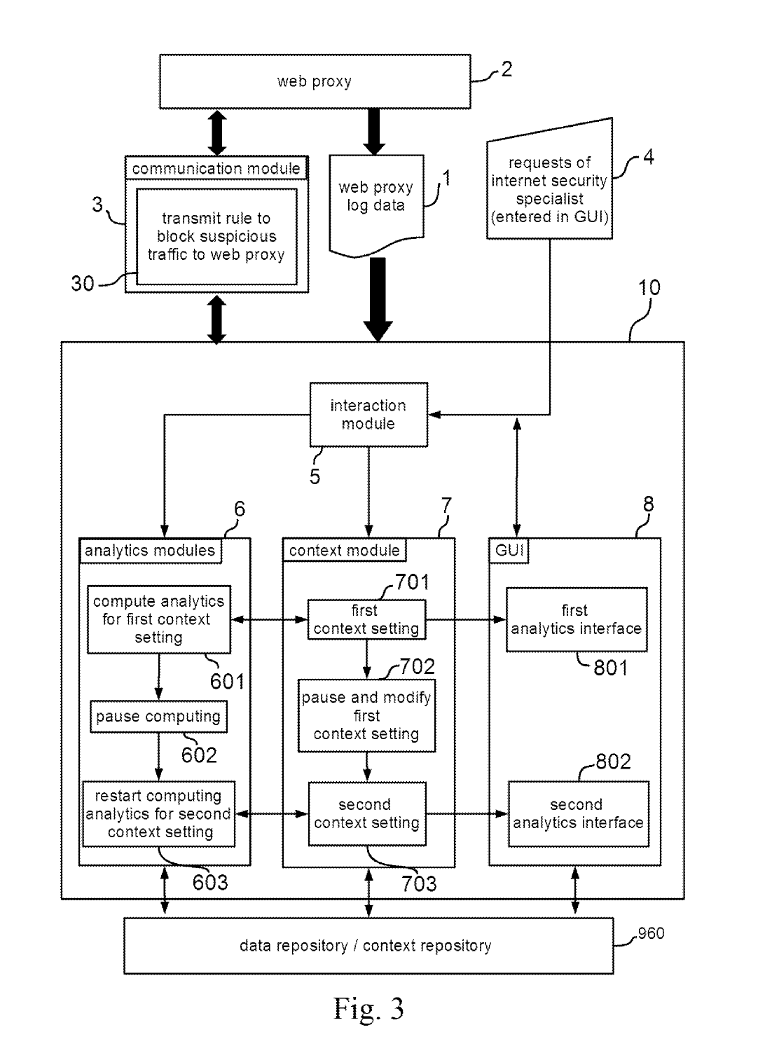

FIG. 1 schematically illustrates an example of a connection of a local area network (LAN) to the Internet via a web proxy. The web proxy is, for example, a proxy server. A proxy server is a server that acts as an intermediary for requests from clients seeking resources from other servers. A LAN 100 made up by a number of computers (e.g. several dozens) is connected to the Internet 101 via a demilitarized zone 99 that servers as an additional security layer. The LAN may be a LAN of an enterprise. The demilitarized zone 99 may comprise a standard webserver 96 (e.g. hosting the Internet presence of the enterprise), a simple mail transfer protocol (SMTP) server 97 (implementing e-mail service for the LAN computers) and a web proxy 2, The web proxy 2 may be a dedicated proxy, for example, adapted for processing Hypertext Transfer Protocol (HTTP) traffic or for processing File Transfer Protocol (FTP) traffic or the like. Furthermore, the web proxy 2 may be a proxy that passes requests and responses basically unmodified, i.e. serves as a gateway, or may be a so called forward proxy used to retrieve traffic from the Internet. In other examples, the web proxy 2 may be a so called reverse proxy used as front-end control to protect access to a server on a private network. The web proxy 2 may, besides establishing communication between the LAN 100 and the Internet, provide for functionalities such as load-balancing, authentication of clients or decryption and encryption of network traffic. Communication between the LAN 100 and the Internet 101 functions, for example, as follows. The web proxy 2 receives a request (e.g. a HTTP request) from a client within the LAN 100 and submits this request to the server in the Internet 101 to which the request is directed as if the request originated from the web proxy 2 itself. The requested Internet server (such as a WWW server or an FTP server) sends a response to the request to the web proxy 2—this response is forwarded by the web proxy 2 to the client of the LAN 100 that initially sent the request. Alternatively, if a response to a certain request is already stored on the web proxy 2, the web proxy 2 may provide the intended result to the requesting client by providing the pre-stored response directly, without having to access the Internet 101. The demilitarized zone 99 may provide its function as an additional security layer, besides other measures, by being equipped with a firewall 98 facing the local area network and a firewall 98 facing the Internet 101. The web proxy 2, SMTP server 97 and standard web server 96 may be located in the demilitarized zone 99. All network traffic between the LAN 100 and the SMTP server 97, between the LAN 100 and the standard web-server 96, between the LAN and the Internet 101 is recorded in a web proxy log data 1. This web proxy log data 1 is analyzed by a web proxy log data analysis system 10 to identify patterns therein that are potentially caused by malware on the LAN computers in order to block network traffic according to the identified pattern. The new web proxy log data analysis system 10 (shown in more detail in FIG. 3) is installed on one of the client computers of LAN 100. The web proxy 2 and the web proxy log data analysis system 10 communicate via a communication module 3, for example, to transmit identified pattern to the web proxy 2 that e.g. changes the configuration of firewall 98 to block traffic according to the identified pattern.

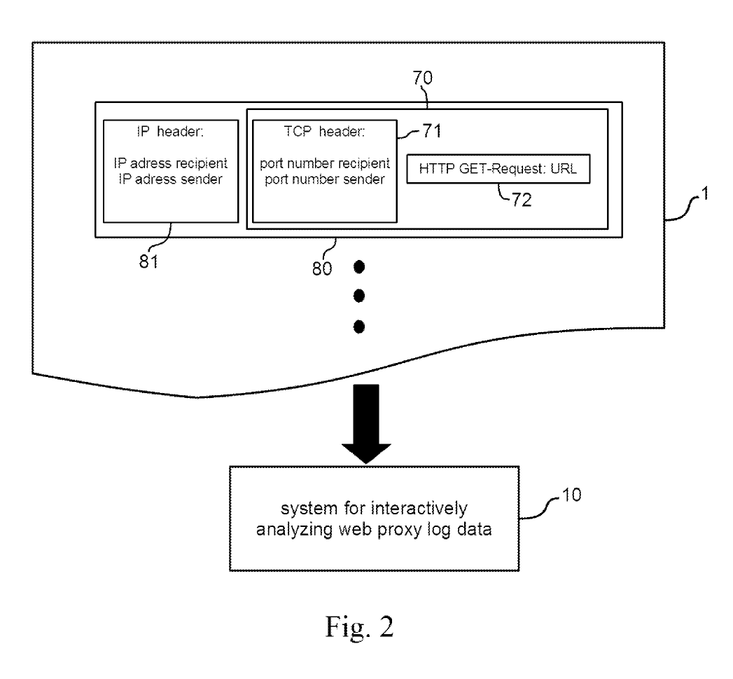

FIG. 2 schematically illustrates a TOP packet containing an HTTP request encapsulated in an IP packet suitable to transport the HTTP request to the Internet. On the application layer, communication between the LAN 100, the web proxy 2 and the Internet 101 (shown in FIG. 1) may be established via the HTTP protocol. A computer of the LAN 100 (shown in FIG. 1), also referred to as client, issues, for example, an HTTP GET-request 72 containing a uniform resource locator (URL) identifying a particular desired website to be opened in the client's browser, to the web proxy 2. On the transport layer, this HTTP GET-request may be encapsulated in a Transmission Control Protocol (TCP) packet including a TOP header. The TOP header may inter glia specify the port number of the intended recipient as well as the port number of the sender port (referring to the application that submits the client's request). On the Internet layer, in turn, the TOP packet may be encapsulated in an Internet Protocol (IP) packet including an IP header. The IP header comprises the IP address of the recipient and the IP address of the sender (the client computer in the LAN 100 that sent the request). Upon receiving the IP packet 80, the web proxy 2 writes the information contained in the aforementioned headers and the HTTP GET-request to the web server log data 1. Hence, the web server log data comprises at least, the URL address of a request, the IP address and port number of the intended recipient as well as the IP address and the port number of the sender. The web proxy log data 1 comprises a plurality of IP packets 80 containing the information mentioned above. The web proxy log data 1 is fed to the new system for interactively analysing web proxy log data 10, so that an SME can perform the analysis inter alfa upon these IP packets 80.

FIG. 3 is a schematic block diagram illustrating a system 10 for interactive analysis of web proxy log data to detect malware capable of providing different context settings for the analysis. A web proxy 2 creates web proxy log data 1 as previously described in conjunction with FIGS. 1 and 2. The web proxy 2 is in communication with a system 10 for interactive analysis of web proxy log data 1 to detect malware via a communication module 3 that is to receive an identified pattern in the web proxy log data 1 potentially caused by malware from the system 10 and to transmit a rule to block traffic according to the identified pattern and to the web proxy 2. The rule may be a set of computer readable instructions providing the web proxy 2 with the ability to become aware of the identified pattern and to block the traffic according to the identified pattern, for example, by not processing client requests according to the identified pattern. Except for transmitting rules to the proxy, also other information (e.g., differences between entities, anomaly scores, cluster descriptions including size, etc.) may also be communicated outside the system (for future user use, as input to another systems or the like).

Requests of a subject matter expert, such as an Internet security expert, are transmitted to the system 10 via input devices (e.g. mouse, keyboard). These requests may concern filtering web proxy log data 1, forming clusters out of web proxy log data 1, modify feature weights of certain web proxy log data features in computing web proxy analytics, etc. The SME controls the system, for example, by selecting a group of records or feature classes on GUI 8 to create a filter or by selecting specific regions of a bar diagram etc. to create a cluster out of the data elements within the selected region etc. System 10 includes an interaction module 5 and context module 7. The context module 7 may access a collection of analytics modules 6 to generate a first analytics interface 801 based on a first context setting 701 indicative of a plurality of parameters of the web proxy log data 1.

In some examples, the web proxy log data 1 may be provided in structured form. In some examples, web proxy log data 1 may be represented as an array. For example, columns may represent features of the data, whereas rows may represent data elements. For example, rows may represent responses received by the web proxy 2 (not shown in FIG. 3), whereas columns may represent the timestamp of the response, the IP address of the intended receiver as well as the IP address of the sender of the response, the specific protocol used on each network layer, such as the information whether the request is an HTTP request, a Hypertext Transfer Protocol Secure (HTTPS) request or an SMTP request and so forth.

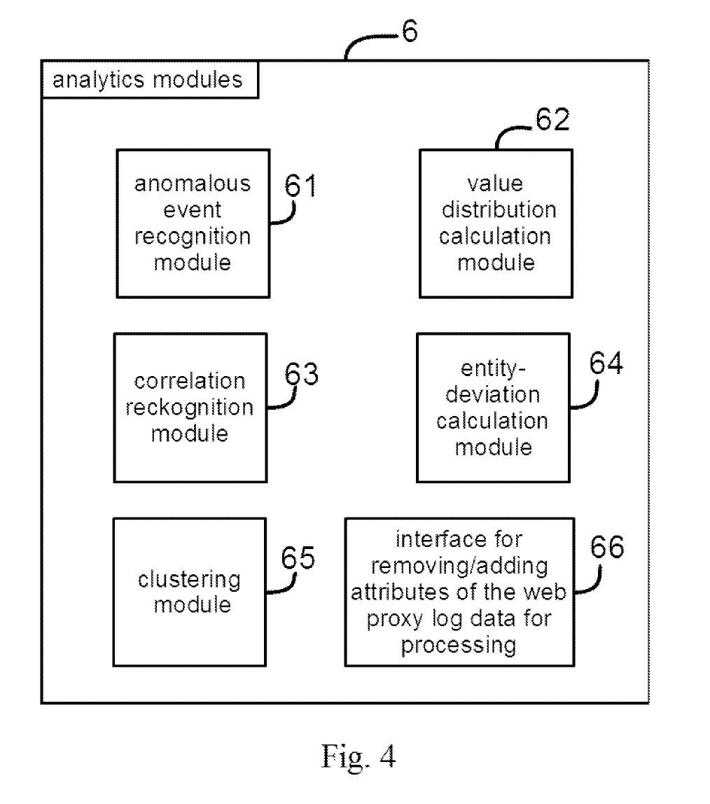

The context module 7 may access a plurality of analytics modules 6. Generally, the analytics modules 6 include a plurality of data analytics processing systems that may be communicatively linked to system 10. These data analytics processing systems correspond to the analytics modules 6, which are further described in conjunction with FIG. 4 below. In some examples, the context module 7 may identify a context setting 701, 703 indicative of a plurality of parameters of the web proxy log data 1. The context setting 701, 703 may include parameters such as filters (e.g. applied to focus on particular features of the web proxy log data), feature weights (e.g., to weight the importance/relevance of each of the features), and so forth. In some examples, the context setting 701, 703 may include derived features. Derived features may be generally inferred from existing features. For example, a column in the array may be for a “timestamp”. A data element may be associated with a value “7-21-2015”, and some features may be derived from such timestamp data. For example, a month, “July”, a date, “21”, a year, “2015”, and a day “Tuesday”, may be inferred from the timestamp value “7-21-2015”

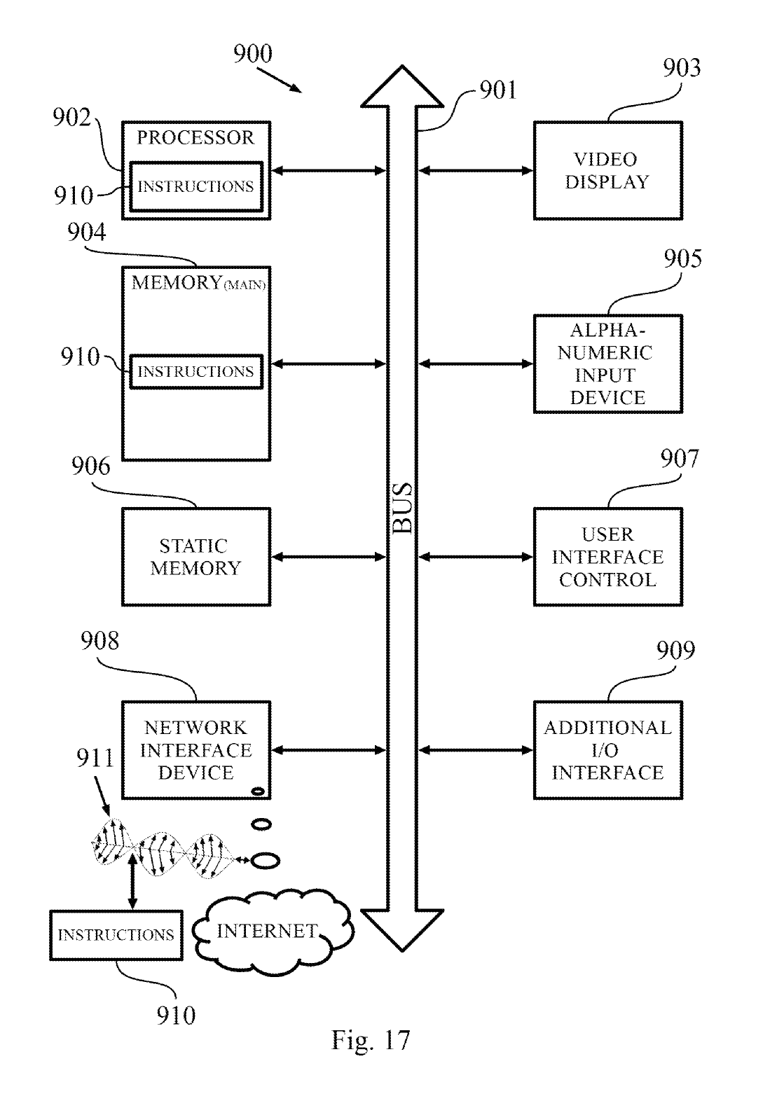

In some examples, such derived features may be associated with feature weights. The context module 7 may automatically run a suite of analytic algorithms from the collection of analytics modules 6, each of which may take as input all the context inputs (data, filters, features, etc.). These algorithms may generally depend on context feature weights. In some examples, the interaction module 5 may provide the analytics interface to a computing device 900 (shown in FIG. 17) via the graphical user interface (GUI) 8. As described herein, an analytics interface 801, 802 is a visual representation of results of the algorithms. The context module 7 may, for example, run an anomaly detection module 61 (shown in FIG. 4) and the analytics interface 801, 802 may provide a visual representation of the data, including any identified anomalous events. An anomalous event is any event (e.g. sequence of requests, change of IP address, status reports) that deviates from “normal” traffic. An expected “normal traffic” can be obtained from probability distributions of web proxy log data attributes or the like. As another example, based on a selection set, the context module 7 may run clustering module 65 (shown in FIG. 4), and the analytics interface 801, 802 may provide a visual representation of the clusters. In some examples, such visualizations may be progressive (e.g., continually updated as more data is received and/or analyzed).

In some examples, the interaction module 5 may identify a requested change in the context setting 701 via an interaction with the GUI 8. A requested change is generally any change in the context setting 701, including changes to filters, features, feature weights, and so forth. For example, a region in a scatterplot may be selected, for example, via drawing a boundary for a selected region, highlighting a selected region with a highlighter or a different color. This may result in a filtering of the web proxy log data 1. For example, the web proxy log data 1 may be filtered based on the geographical origin of requesting clients, for example, taken from the “whois” record of the sender's IP address. As another example, the web proxy log data 1 may be filtered based on the frequency of requests, by observing only ports over which requests are sent in a frequency that exceeds a given frequency threshold. Also, for example, network traffic data represented via an interactive map may be selected by selecting a region of the displayed map. Also, for example, the interaction module 5 may identify a modification of a feature weight. For example, a higher feature weight may be associated with a column in the web proxy log data 1 indicating the HTTP status codes (e.g. 403: “forbidden” or 301: “moved permanently”).

In some examples, the interaction module 5 may prompt the context module 7 to pause generation of the first analytics interface 801 in response to the requested change. For example, the analytics interface 801, 802 may be based on an anomaly detection module 61 (shown in FIG. 4). In some examples, the interaction module 5 may identify a requested change related to the first analytics interface. For example, the interaction module 5 may identify a selection of an anomalous event. Based on such a selection, the interaction module 5 may prompt the context module 7 to pause the generation of the first analytics interface 801.

In some examples, the context module 7 and/or the interaction module 5 may store data related to the first analytics interface 801 in a data repository and/or a context repository 960. For example, each context setting 701, 703, and its associated analytics interface may be stored in the data repository and/or context repository 960. In some examples, system 10 may include a stand-alone context repository 960 that may store data related to the analytics processes. Such a data repository and/or context repository 960 may be a single database or a collection of databases. In some examples, the collection of databases may be spatially and/or temporally distributed. Such a data repository and/or context repository 960 may be accessible to context module 7 and/or the interaction module 5. For example, any saved context setting 701, 703, analytics interface 801, 802, and/or analytics module may be made available to the computing device 900 (shown in FIG. 17) controlled by the SME. Also, for example, the interaction module 5 may identify selection of a saved context setting 701, 703, analytics interface 801, 802, and/or analytics module 6, and the context module 7 may access it from the repository. In some examples, the context module 7 may modify the first context 701 setting based on the requested change to create another context setting, e.g. the second context setting 703. Generally, when a change in the first context setting 701 (i.e., filters, features, feature weights, etc.) is identified via an interaction, the computation of a current web proxy log analytics (the web proxy log analytics for the first context setting) is paused, and progressively processing the web proxy log data 1 to compute web proxy log analytics is restarted for the changed first context setting 701, corresponding to the second context setting 703. Thereby, subsequent or more specific web proxy analytics—which can be considered to be a child web proxy analytics of the previous web proxy log analytics—are computed. The child analytics, for example, inherit all the results that are not affected by the requested change, and re-computes everything else. The results of the web proxy log analytics for the second context setting 703 are displayed by the second analytics interface 802 on the GUI 8.

For example, the context module 7 may, via a self-learning anomalous event recognition module 61 (being part of the analytics modules 6—shown in FIG. 4), identify events similar to the anomalous events previously identified by the anomalous event recognition module 61 by processing the web proxy log data 1 and computing web proxy log analytics. To provide another example, the interaction module 5 may identify a requested modification of feature weights in progressively processing web proxy log data 1 to compute web proxy log analytics and computing web proxy analytics is restarted upon the creation of the second context setting 703 related to the requested modification of feature weights. In response to this change of feature weights, the context module 7 also generates a new analytics interface 802.

In some examples, the context module 7 may provide the new analytics interface 802 via the graphical user interface 8. For example, a requested change to a first analytics interface 801 based on a first context setting 701 may be identified. As described herein, the context module 7 may pause the generation of the first analytics interface 801, and generate a second analytics interface responsive to a second context setting (e.g., a modified first context setting). The context module 7 may provide the second analytics interface 802 via the graphical user interface 8. As described herein, the second analytics interface 802 may be progressive (e.g., continually updated as more data is received and/or analyzed).

In some examples, such steps may be iteratively repeated to provide further insights into the web proxy log data 1.

In some examples, the context module 7 may store the paused first analytics interface 801, and the interaction module 5 may provide a first selectable menu option associated with the paused first analytics interface 801. Generally, an iterative interaction via the graphical user interface 8 may generate a sequence of analytics interfaces, for example, X1, X2, . . . , Xn, where X1, X2, . . . , Xn−1 may be paused analytics interfaces, and Xn may be a currently running analytics interface. The context module 7 may store the paused analytics interfaces X1, X2, . . . , Xn−1 and provide selectable menu options associated with each of the paused analytics interfaces.

In some examples, the interaction module 5 may identify a selection of a selectable menu option associated with one of the paused analytics interfaces. For example, the interaction module 5 may identify a selection of a selectable menu option associated with the third paused analytics interface X3. Accordingly, the interaction module 5 may prompt the context module 7 to pause generation of the currently running analytics interface Xn and the corresponding computation of web proxy log analytics for the current context setting in response to the selection, and may continue generation of the third paused analytics interface X3, hence prompting the analytics modules 6 to restart progressively processing the web proxy log data 1 to compute web proxy analytics with a starting point for the calculation corresponding to the point in which the calculation of the web proxy log analytics for the third analytics interface was stored. Generally, the interaction module 5 may access any previously stored analytics interface in a sequence of generated analytics interfaces, and continue generation of the paused analytics interface.

The system of FIG. 3 is thus used by an SME for detecting malicious events in the web proxy log data 1 that are not (yet) detected by existing rules blocking traffic caused by already recognized malware in the LAN 100. The SME may provide the web proxy log data 1 to system 10. The context module 7 may access a collection of analytics modules 6 to generate a first analytics interface 801 on the web proxy log data 1, which computes statistics, anomalies, common clusters, and aggregates anomalies, for example by scoring specific anomalies and calculating a weighted mean of these anomalies. Subsequent analytics interfaces 802 are generated in response to context changes from the SME's input via the GUI 8.

FIG. 4 is a schematic block diagram illustrating analytics modules provided in the system. For example, the analytics modules 6 may include an anomalous event recognition module 61 that processes the web proxy log data 1 to detect anomalous events, in particular, for example, top anomalous events. A top anomalous event may be an extraordinary outlier in a statistical distribution of data attributes of the web proxy log data 1, for example, an outlier of specific feature values. The term outlier, as used herein, may refer to a rare event, and/or an event that is distant from the norm of a distribution (e.g., an extreme, unexpected, and/or remarkable event). For example, the outlier may be identified as a data attribute value that deviates from an expectation of a probability distribution by a threshold value. Generally, the anomalous event recognition module 61 may identify what may be “normal” (or non-extreme, expected, and/or unremarkable) in the distribution of values of data attributes, e.g. status codes of a request, and may be able to select outliers that may be representative of rare situations that are distinctly different from the norm. In some examples top anomalous events may be identified based on an expectation value of the probability distribution of the data attribute(s) observed, To provide an example, a deviation of the percentages of requests using the HTTPS protocol from an expectation value of a probability distribution of HTTPS usage that exceeds a given threshold, may be such a top anomalous event. The distribution values for data elements, e.g. data attributes, utilized by the anomalous event recognition module 61, are calculated by a value distribution calculation module 62. The distribution calculated by the distribution calculation module 62 may be uniform, quasi-uniform, normal, long-tailed, or heavy-tailed and may be based on Gaussian distributions, Gaussian mixture models, Poisson distribution, binomial distributions or the like.

As another example, the analytics modules 6 may include a correlation recognition module 63. The correlation recognition module 63 may detect a number of anomalous correlations within the web proxy log data 1. In this way, the correlation recognition module 63 identifies correlations that may be indicative of malware either according to requests of the SME or automatically. A correlation is to be understood in this context as a correlation between web proxy log data attribute values. For example, the correlation automatically scanned by the correlation recognition module 63 is a correlation between port numbers active in transporting data packets and the underlying transport protocol used. For example, port number “1003” with transport protocol TCP might indicate a Trojan attack.

Another exemplary module of the analytics modules is the entity-deviation calculation module 64. The entity-deviation calculation module 64 may calculate and rank an entity deviation between entity statistical distributions within the web proxy log data 1. It is to be noted that the entities according to the present disclosure are not necessarily electronic devices but can be any entity with comparable behavior. They are also not limited to physical and/or connected entities. Entities need not be real entities of the computer network. These may be also sub-networks connected to the web proxy, groups of network users or computers, or entities defined by, e.g., source address=“XYZ” AND protocol=“X” meaning that entities are actually IPs communicating over a certain protocol X. In general, entity deviations are calculated by calculating distance(s) in the space of features' statistics. Hence, an entity deviation is a function of distances between features distributions. It bases distance definition between values on distance in the statistical feature space rather than in the original values space. The final output of the entity-deviation calculation module 64 may be a ranking according to a detected abnormal behavior without needing to identify what is “normal” first. This is achieved through the use of cumulative statistical analysis to define and quantify a “statistical distance” between different entities within a system. A statistical distance quantifies the distance between two statistical objects, for example two random variables, two probability distributions, or the distance between an individual sample point and a population or a wider sample of points. They quantify how different two statistical objects, such as probability distributions, are from each other. Some types of distance measures are referred to as (statistical) divergences which establish the “distance” of one probability distribution to the other on a statistical manifold. This distance calculation may be carried out for a multi-entity system, such as a computer network. An empirical probability distribution function of a chosen feature may be derived for each computer in the network. Pair-wise statistical distances between each derived probability distributions are calculated and ranked for each computer based upon the measure of dissimilarity between the empirical event probability distribution data for each device on the network. The feature under investigation may be network traffic over time, e.g. occurring each second. Alternatively this comparison may be accomplished for a plurality of different features extracted out of the web proxy log data 1 for a plurality of entities in communication with the web proxy 2. The measure chosen to calculate the statistical distance between the entity probability distribution may be, for example, the Kullback-Leibler (K-L) Divergence.

As another example, the analytics modules 6 may include a clustering module 65 that processes web proxy log data 1 to identify and/or form clusters of data elements. The clustering module 65 may cluster web proxy log data 1 according to a distance in a feature space of the web proxy log data 1. In general, clustering is the task of grouping a set of objects in such a way that objects in the same group (cluster) are more similar to each other than to those in other groups (other clusters). For example, the SME may assign some log data entries to a certain class of log data entries. For example, the SME may classify (separate into different classes) web proxy log entries that show a suspicious combination of port number and transport protocol used as well as suspicious status codes and such that do not. The assigned log data entries may be used as training data for subsequent automatic clustering. Each of the n attribute values of web proxy log data entry may represent a dimension in an n-dimensional feature space in which the web proxy log data 1 is clustered. The clustering module 65 may utilize Regularized Least Squares (RLS) classification to learn to classify the web proxy log data 1 based on the training data. For each log data entry, a likelihood might be generated for the point to belong to a certain class.

Also, for example, the analytics modules 6 may include a cohort service (not shown in the Figures) that processes the web proxy log data 1 to identify cohorts of similar data elements. As another example, the analytics modules 6 may include a classifier service (not shown in the Figures) that processes the web proxy log data 1 to deploy a classifier to perform machine learning operations based on interactions via a computing device, for example, computing device 900 as shown in FIG. 17. In some examples, the analytics modules 6 may include additional modules (not shown in the Figures), such as, for example, an information links module that provides results to a search query for information the SME controlling the system requires. The analytics modules 6 may further comprise an aggregative analysis module that provides analysis based on temporal and/or spatial parameters. Furthermore the SME can remove and add attributes of the web proxy log data 1 for processing, for example, discard some attributes as not important, by an interface for removing/adding attributes of the web proxy log data for processing 66.

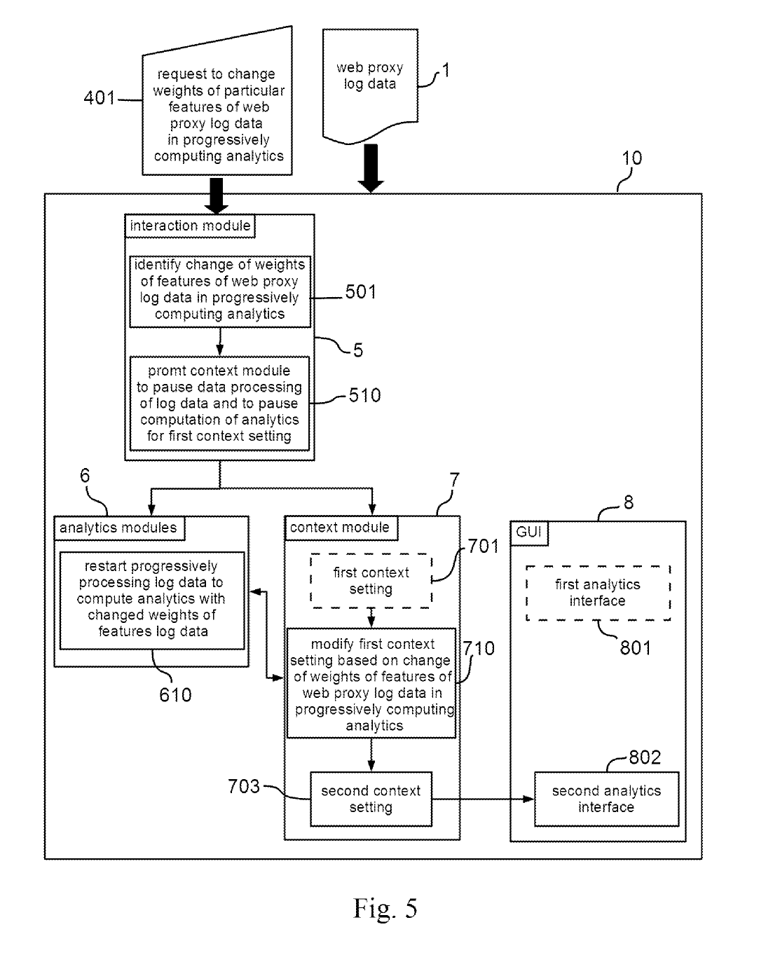

FIG. 5 is a schematic block diagram of the system processing a request to change weights of features of web proxy log data in computing analytics for a context setting. The SME submits a request to change weights of features of web proxy log data in progressively computing analytics 401 to the system 10. To provide an example, the SME may detect, via the graphical user interface 8, that top anomalies previously identified are mostly anomalous because of the “byte in” field, and the SME may determine that this as not relevant to the current analysis. Thus, the SME may decrease a feature weight associated with feature for the field “byte in”. The interaction module 5 may identify this change of the weight of the feature in progressively computing analytics 501. The interaction module may prompt to pause the progressive processing of the web proxy log data and to pause the computing analytics for the first context setting in response to the requested change 510, for example, the requested change of the weight associated with the feature for the field “byte in”. Thereupon, the context module 7 modifies the first context setting based on the change of weights of the features of the web proxy log data in progressively computing analytics and thereby creates a second context setting 710. The analytics module 6 restarts progressively progressing the web proxy log data to compute web proxy log analytics for the second context setting upon the creation of the second context setting 610. In the above example, the first context setting 701 would be a setting in which every feature of the web proxy log data has the same weight, the second context setting would be a setting in which the feature weight associated with the feature for the field “byte in” is decreased. Upon the creation of the second context setting 703 the first analytics interface 801 is paused and a second analytics interface 802 corresponding to the second context setting 802 is provided to the computing device 900 controlled by the SME via the GUI 8.

In some examples, the SME does not only change weights but you may also change the usage of certain features, e.g. by excluding some features, such as attributes of the web proxy log data 1, from the computation of analytics. This is equivalent to setting the weight of the respective features to zero. The SME might also choose to see a certain feature but not to include it in computing analytics. In this case, the feature value is still displayed on the analysis interface although its value does not play any role in the analytics.

In some examples, the interaction module 5 may identify an attribute in the processed web proxy log data 1 that has been associated with a higher feature weight by the SME. Accordingly, the context module 7 may apply the higher feature weight to filter the web proxy log data 1 in such a way that only data with feature weights higher than a threshold may be included progressively processing the web proxy log data 1 and calculating web proxy log analytics. In this way, a second context setting 703 may be created in which only web proxy log entries with a sufficient feature weight are further analyzed.

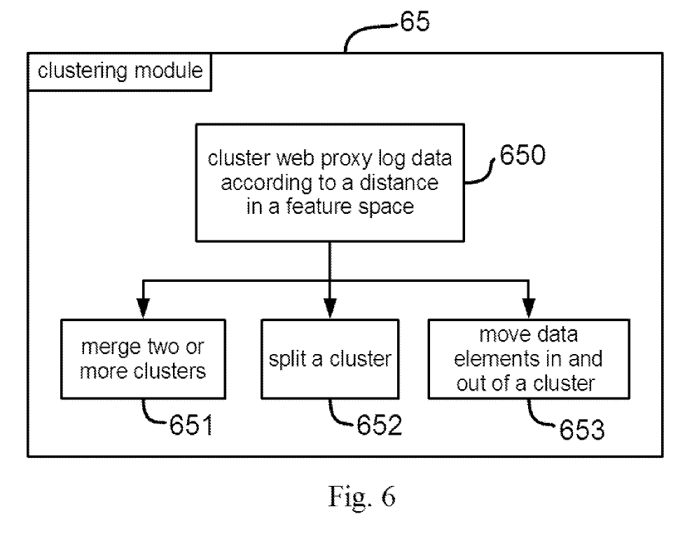

FIG. 6 is a schematic block diagram further illustrating the aforementioned clustering module 65. The clustering module 65 is a part of the analytics modules 6 that is to cluster web proxy log data according to a distance in a feature space 650, as described above. Furthermore the clustering module 65 is to merge two or more clusters 651, which is to form one cluster out of at least two separated clusters, wherein the number of web proxy log data elements remains constant under this procedure. Besides that, the clustering module 65 is to split a cluster 652 into at least two smaller clusters and to move data elements in and out of a cluster 653. These functionalities of the clustering module 65 are carried out either upon request of an SME to the system 10 or automatically when progressively processing web proxy log data 1 to compute web proxy log analytics for a specific context setting 701, 703.

In some examples, the interaction module 5 is to identify the creation or the change of at least one filter for removing events within the web proxy log data 1 or focusing on specific types of events within the web proxy log data 1 as a requested change of the first context setting 701 and the context module 5 is to modify the context setting 701 based on the creation or the change of the at least one filter.

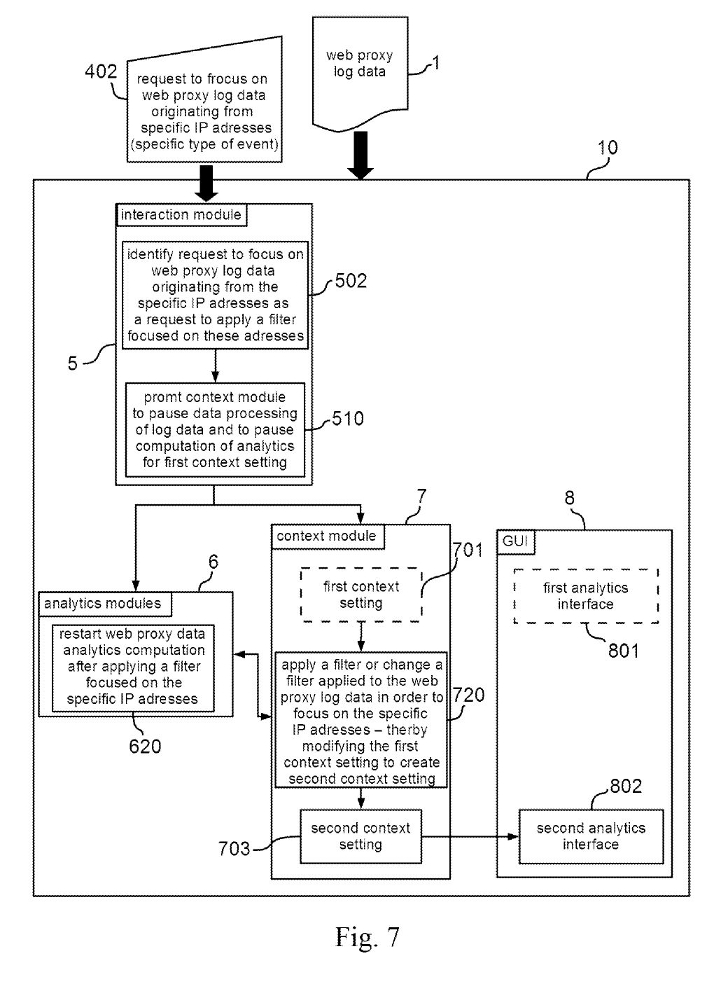

FIG. 7 is a schematic block diagram of the system processing a request to focus on web proxy log data 1 originating from specific IP addresses. In the example illustrated by FIG. 7, an SME submits a request to focus on web proxy log data originating from specific IP addresses 402 to the system 10. This corresponds to a creation or a change of a filter to focus on a specific type of event, for example, to a focus on specific target IP addresses that have a “whois” record originating from a Chinese province where a business competitor has settled. The SME may also move specific groups of IP addresses in and out of the requested focus arbitrarily. The interaction module 5 may identify the request to focus on web proxy log data 1 originating from specific IP addresses as a request to apply a filter focused on this addresses 502. Upon receiving this request 402 the interaction module 5 prompts the context module to pause the progressive processing of the web proxy log data and to pause the computing analytics for the first context setting 510. The context module 7 applies a filter to the web proxy log data 1 to focus on the specific IP addresses and thereby modifies the first context setting to create the second context setting 720. The second context setting 703 may be created by removing all other events that do not originate from these specific IP addresses out of the first context setting 701. This may also be achieved by changing a filter already applied accordingly. Upon the creation of the second context setting 703, the analytics modules 6 may restart progressively processing the web proxy log data 1 to compute web proxy log analytics for the second context setting 703 by only taking the filtered out IP addresses into account when calculating the analytics. Correspondingly, the first analytics interface 801 representing the unfiltered web proxy log analytics is paused and a second analytics interface 802 related to the second context setting 703 is created.

In some examples, the SME may start by comparing IPs and later on decide to compare network activity. Alternatively, one may wish to start by comparing source IPs and then to compare IPs operating on certain protocol. Hence, focusing on specific IP addresses (which is the scope of the example illustrated by FIG. 7) is only one example of focusing on specific features of the web proxy log data 2. There are plenty of possibilities of how to define an aggregative entity to put a focus on—it may be defined with IPs and if one wishes some of the IPs can be filtered out, or it can be defined otherwise, using any network feature such as a subnet-mask or a combination of these as entity definition-base. Each entity-definition will open a separate context.

In some examples, a context setting 701, 703 may comprise two broad classes of filters, a selection filter set and a reference filter set. The selection filter set may include filters. Generally, a selection filter set may indicate which attribute rows of the web proxy log data 1 are to be considered as selection by the analytics modules 6. The reference filter set may include filters, which may be different from the selection filters. Generally, a reference filter set may indicate which attribute rows of the web proxy log data 1 are to be considered as reference by the analytics modules 6. For example, a selection filter set could indicate a single user-selected anomalous event (row) is included in the selection set, whereas all other events (rows) may be indicated by the reference filters set. In this case, we say that the user-selection anomalous event are included in the selection, whereas all the other events are included in the reference. As another example, in the case that web proxy log data 1 has been clustered by the clustering module 65, events in a selected cluster of anomalous events are included in the selections set of anomalous events, whereas events from another cluster may be included in the reference set. Upon request of a SME, the context module 7 may filter the web proxy log data 1 to identify rows in the web proxy log data 1 (e.g. when provided as tabular array) that are in the same cluster as the selected anomalous event and are therefore to be considered as potentially caused by malware. By applying this filter, a new context setting and a new analytics interface is created.

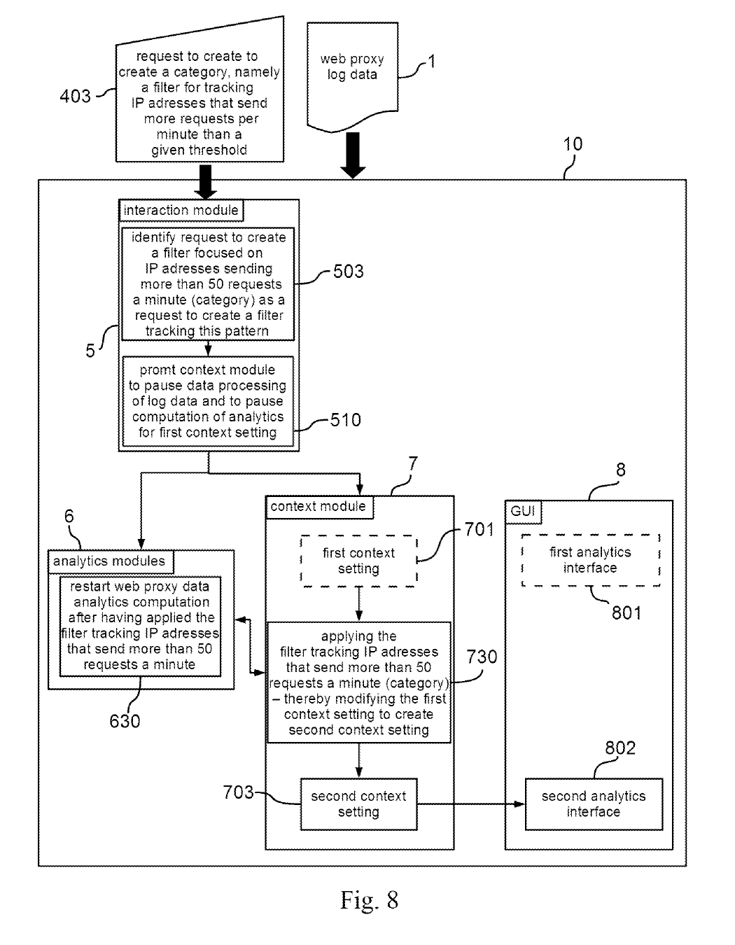

FIG. 8 is a schematic block diagram of the system processing a request to create a filter for tracking a specific behavior. Such filters for tracking a specific behaviour are also referred to herein as categories. A SME may request the system to create a filter (category) for tracking IP addresses that send more requests per minute than a given threshold 403. The SME may classify this behavior of entities in a computer network as an anomalous event to be tracked. The given threshold is, for example, manually entered by the SME. The interaction module 5 identifies this request to create a filter focused on IP addresses sending more requests per minute than the given threshold 503. Thereupon, the interaction module prompts the context module to pause the progressive progressing of web proxy log data and prompts the analytics modules to pause computing analytics for the first context setting 510. The context module 7 applies a filter tracking the IP addresses that send more requests per minute than the given threshold and thereby modifies the first context setting to create a second context setting 730. The context module 7 generates a second analytics interface 802 based on the second context setting 703. Subsequent to the application of the filter tracking IP addresses that send more requests per minute than the given threshold, in this example corresponding to the creation of the second context setting 703, the analytics modules 6 restart web proxy analytics computation for the now filtered data to provide analytics for a second analytics interface 802. The second analytics interface 802 may be inherited from the first analytics interface 801. Analytics interface features that do not change due to the applied filter may be taken over from the first analytics interface 801, The second analytics interface 802 may be displayed on the GUI 8.

Also, for example, the SME may decide to investigate two different anomalies, which appear to be similar. To provide an example, some IP addresses of a subnetwork exceedingly submit requests while other IP addresses of the same sub network exceedingly receive requests. The SME may select these anomalies, and new context setting 701, 703 is created, for which the reference set may be the entire web proxy log data 1. Now the context module 7 may access a cohort service from the collection of analytics modules 6 to identify events similar to the selected anomalies. The context module 7 may access a classifier service to produce and deploy a classifier, which may be displayed via the GUI 8, to detect similar events in the future.

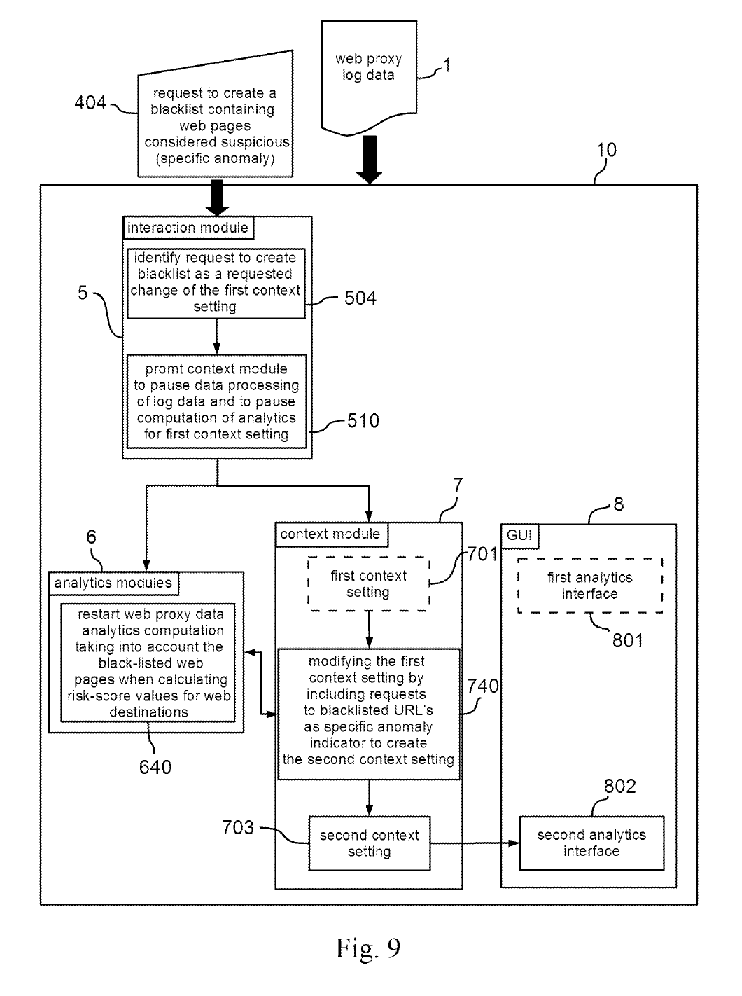

FIG. 9 is a schematic block diagram of the system processing a request to focus on a specific anomaly. For example, an SME submits a request to the system 10 to create a blacklist containing web pages considered suspicious, e.g. a likely source of malware downloads 404. The interaction module 5 identifies the request to create the blacklist as a requested change of the first context setting 504. As a consequence, the interaction module prompts the context module to pause progressive processing of the web proxy log data and prompts the analytics modules to pause computing analytics for the first context setting 510. The context module 7, after being informed about the requested change of the first context setting by the interaction module 5, modifies the first context setting by including requests containing URL's matching a blacklist entry as a specific anomaly indicator 740. By including this new specific anomaly indicator, a second context setting 703 is created. Correspondingly, the analytics modules 6 restart analytics computation upon the creation of the second context setting 703 by taking into account the black-listed web pages when calculating risk-score values for web destination 640, e.g. by assigning a higher risk-score value to the black-listed web sites. The context module 7 generates a second analytics interface 802 responsive to the second context setting 703. As described above, this new interface 802 may be inherited from the first analytics interface 801.

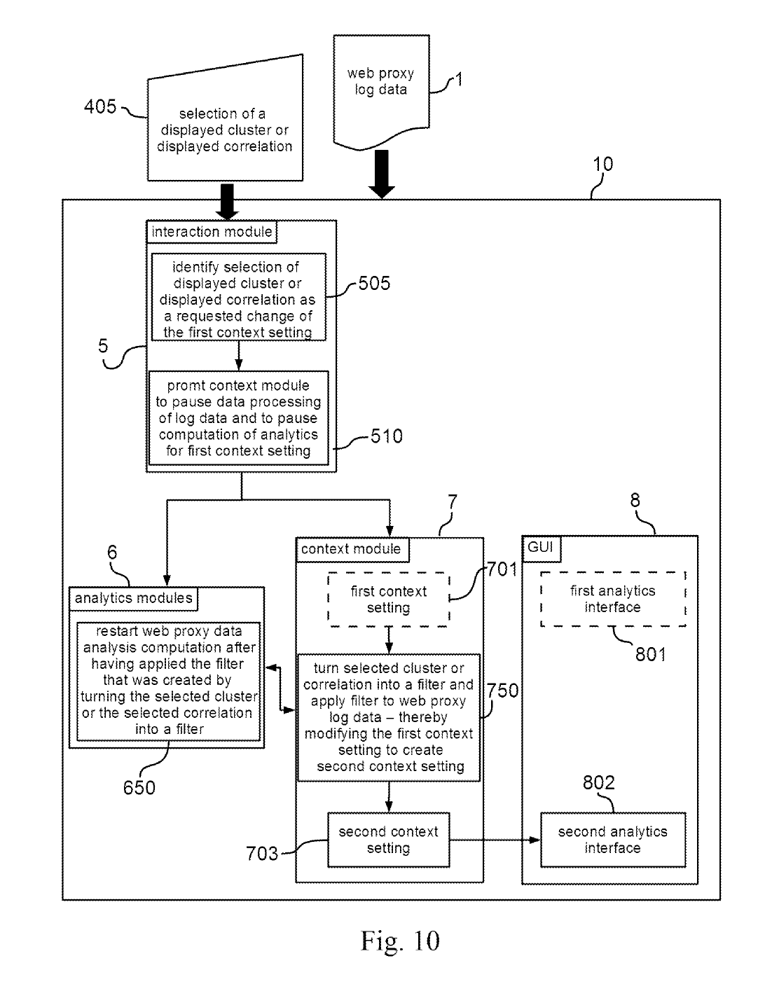

FIG. 10 is a schematic block diagram of the system processing a selection of a cluster or a correlation displayed on a GUI. The clustering module 65 of the analytics module 6 (shown in FIG. 6) may, by default, cluster data with common features of significance. At the same time, the correlation recognition module 63 (shown in FIG. 4) will determine correlations between data elements, as described above. The resulting clusters and correlations of web proxy log data elements may be displayed via a first analytics interface 801. A displayed correlation is a visual representation of a correlation between data attributes on the GUI 8. The correlation may be visualized by a bar diagram illustrating the prevalence of a certain combination of attributes, for example, for a specific group of computers within LAN 100. A displayed cluster is a visual representation of a cluster of data elements of web proxy log data 1 on the GUI 8. The visual representation may be for example a point cloud of data elements in a multidimensional feature space, for example with a drop-down list to select the attributes to be displayed. An SME may select a displayed cluster or a displayed correlation 405, e.g. by clicking on a specific point cloud representing the cluster. The interaction module 5 may identify the selection of the displayed cluster or displayed correlation as requested change of the first context setting 505. The interaction module 5 may prompt the context module to pause the progressive processing of the web proxy log data and to pause the computing analytics for the first context in response to the requested change 510. The context module 7 may thereupon turn the selected cluster or correlation into a filter focusing only on data elements with features like the selected cluster or correlation and may apply that filter to the (entire) web proxy log data 750. In this way, the first context setting 701 is modified to create a second context setting 703. Responsive to the second context setting 703, the context module 7 generates a second analytics interface 802. Correspondingly, the analytics modules 6 may restart progressively processing the web proxy log data to compute web proxy log analytics after the filter, created by turning the selected cluster or correlation into a filter, was applied to the web proxy log data 650. Only the data elements passing the filter are considered in the analysis computation now. The newly calculated analytics are displayed on the second analytics interface 802 via GUI 8.

In some examples, the SME may observe, via GUI 8, that a cluster identified by the clustering module 65 (shown in FIG. 6) is of normal, uninteresting traffic (e.g., http status 200-OK, proxy action=OBSERVED, low URL randomness, etc.). The SME may decide to filter this common cluster out of the web proxy log data 1. The interaction module 5 may identify a requested change in the first context setting 701 via an interaction with the GUI 8. This creates a second analytics interface 802, a child of the first analytics interface 801, characterized by turning the common cluster to an out-filter, i.e. a filter that is to remove elements that correspond to the common cluster from the web proxy log data analysis. The generation of the first analytics interface 801 is paused and stored on a data repository/context repository 950 and the second analytics interface 802 is generated based on statistics, anomalies, common clusters, entity-deviation, and aggregate anomalies etc. for a second context setting 703. The interaction module 5 may provide the second analytics interface 802 to the computing device via GUI 8, The SME may examine the new clusters computed by the clustering module 65 (shown in FIG. 6) based on the second context setting 703. The SME may detect a second common cluster (e.g., protocol=TCP, port=443, status=200-OK, etc.), and may decide to filter out the second common cluster. This creates a third context setting, generation of the second analytics interface 802 is paused, and all the analytics are computed for a third analytics interface (not shown in FIG. 10). The context module 7 generates the third analytics interface, a child of the second analytics interface 801, 802. Again this third analytics interface is presented to the SME by GUI 8. The SME may now detect a cluster that appears to be suspicious, and may decide to focus on the suspicious cluster. The SME may therefore convert the suspicious cluster into a “focus-on filter”, that is a filter that removes all the data elements which are not to be focused on, thus creating a fifth context setting (not shown in FIG. 10), generation of the fourth analytics interface (not shown in FIG. 10) is paused, and all the analytics are computed for a fifth analytics interface. The SME may observe that several anomalies among anomalies, e.g. calculated by the by the anomalous event recognition module 61 (shown in FIG. 4) and presented the GUI 8, are indeed threats. The SME may decide to save the fifth context setting and the fifth analytics interface for future use on additional data by storing it on the data repository/context repository 950.

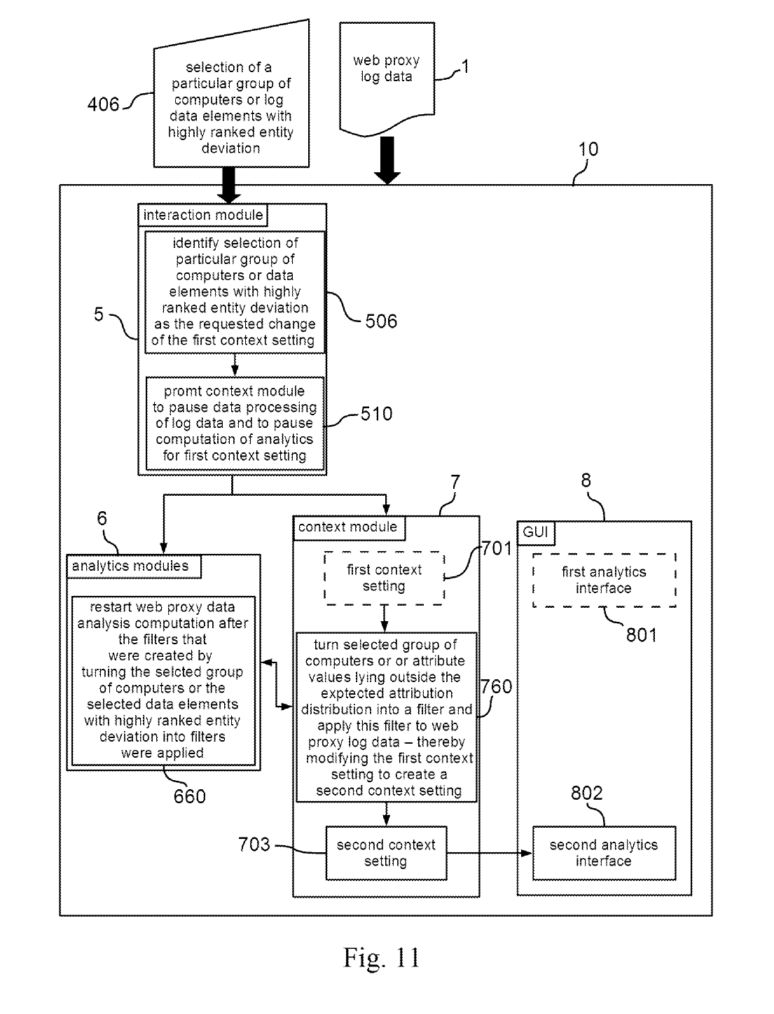

FIG. 11 is a schematic block diagram of the system processing a selection of a particular group of computers or a selection of log data with suspicious attribute values. An SME may select a particular group of computers in the network connected to the web proxy 2 with a highly ranked entity-deviation values, as described above, or log data elements of the web proxy log data with attribute values lying outside an expected attribute distribution 406. The interaction module 5 may identify the selection of a particular group of computers with a highly ranked entity deviation or log data elements with attribute values lying outside an expected attribute distribution as a requested change of a first context setting 506. The context module 7 may turn the selected group of computers or data elements with attribute values lying outside the expected attribute distribution into a filter and may apply this filter to web proxy log data 1, thereby modifying the first context setting to create a second context setting 760. Responsive to that second context setting 703, the context module 7 may generate a second analytics interface 802 that is a child of a first analytics interface 801. Correspondingly, the analytics modules 6 restart progressively processing the web proxy log data to compute web proxy analytics for the second context setting, by recalculating the analytics after the filters that were created by turning the selected group of computers or the selected log data elements with attribute values lying outside the expected attribute distribution into filters have been applied 660. In this way, analytics are computed for the second analytics interface 802. The second analytics interface 802 may be displayed on GUI 8.

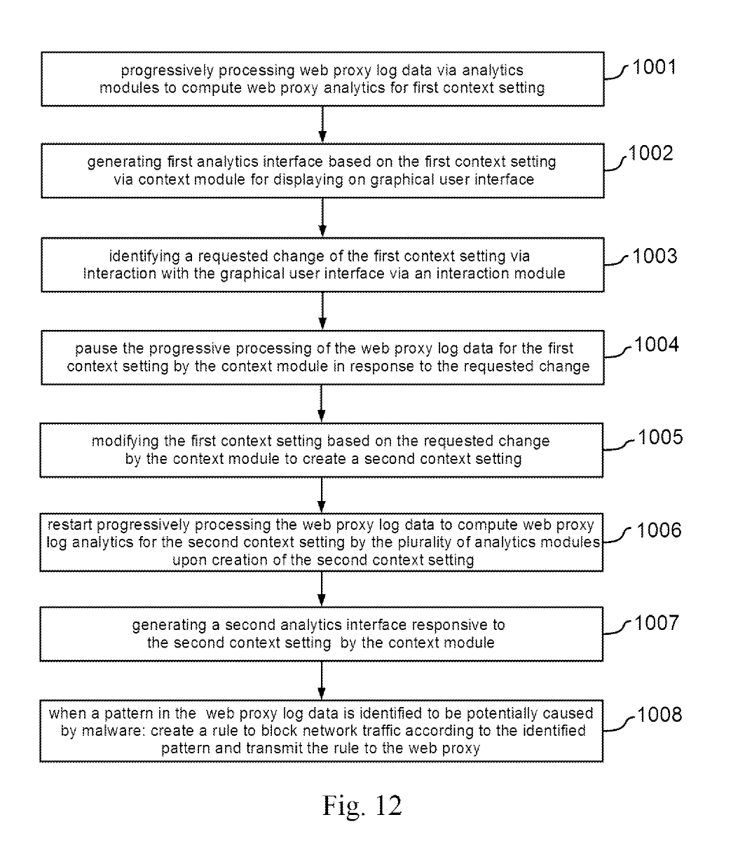

FIG. 12 is a flow diagram illustrating a method of interactively analyzing web proxy log data for malware detection using different context settings. in some examples, such an example method may be implemented by a system such as, for example, system 10 of FIG. 3.

At 1001, a plurality of analytics modules may be accessed via a processing system to progressively process web proxy log data to compute web proxy log analytics for the first context setting.

At 1002, the first analytics interface may be generated by a context module based on the first context setting for being displayed on a graphical user interface.

At 1003, a requested change of the first context setting may be identified via an interaction with the graphical user interface by an interaction module.

At 1004, the progressive processing of the web proxy log data for the first context setting by the context module may be paused in response to the requested change.

At 1005, the first context setting may be modified by the context module based on the requested change to create a second context setting.

At 1006, the progressively processing of the web proxy log data may be restarted to compute web proxy log analytics for the second context setting upon creation of the second context setting.

At 1007, a second analytics interlace is generated by the context module responsive to the second context setting.

At 1008, when a pattern in the web proxy log data is identified to be potentially cause by malware, a rule is created to block network traffic according to the identified pattern and the rule is transmitted to the web proxy.

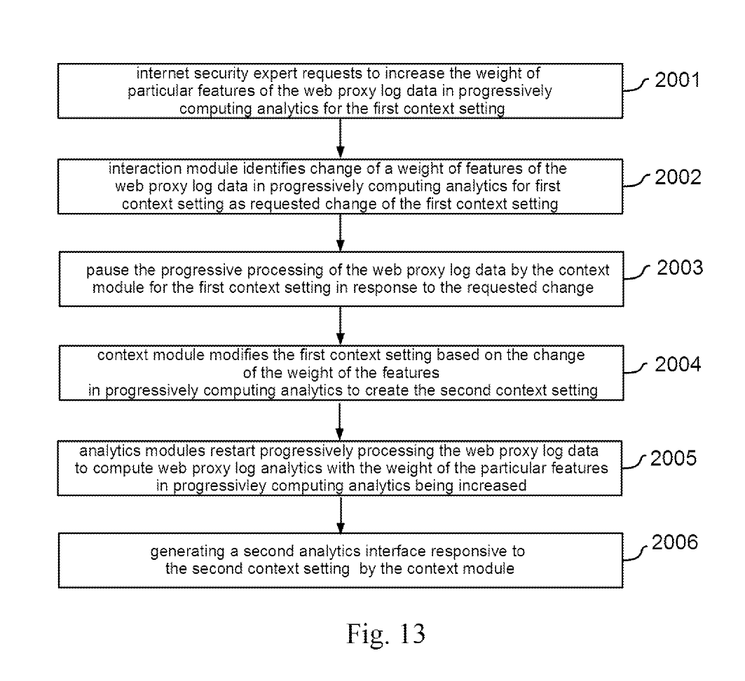

FIG. 13 is a flow chart illustrating the method, wherein a request for increasing the weight of particular features in computing analytics for a context setting is processed.

At 2001, it is requested by an SME to increase the weight of particular features of the web proxy log data in progressively computing analytics for the first context setting.

At 2002, the change of a weight of features of the web proxy log data in progressively computing analytics for the first context setting is identified as a requested change of the first context setting.

At 2003, the progressive processing of the web proxy log data for the first context setting by the context module is paused in response to the requested change.

At 2004, the first context setting is modified by the context module based on the change of the weight of the features in progressively computing analytics to create the second context setting.

At 2005, progressively processing of the web proxy log data is restarted by the analytics modules to compute web proxy log analytics with the weight of the particular features in progressively computing analytics being increased.

At 2006, a second analytics interface is generated responsive to the second context setting by the context module.

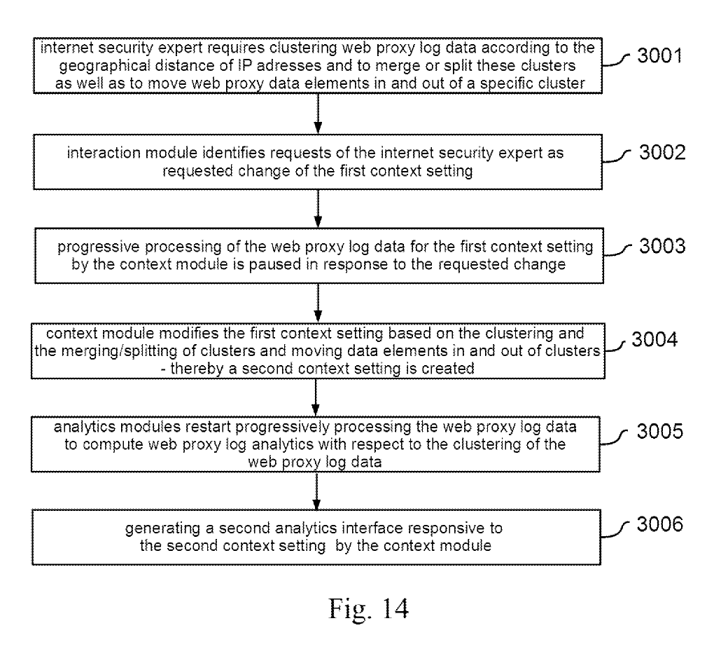

FIG. 14 is a flow chart illustrating the method, wherein a request for clustering web proxy log data according to a geographical distance of IP addresses and to merge and to split the created clusters is processed.

At 3001, clustering web proxy log data according to the geographical distance of IP addresses is required by an SME. The SME further requires to merge or split these clusters as well as to move web proxy data elements in and out of a specific cluster.

At 3002, the requests of the SME are identified as a requested change of a first context setting by the interaction module.

At 3003, the progressive processing of the web proxy log data for the first context setting by the context module is paused in response to the requested change.

At 3004, the first context setting is modified by the context module based on the clustering and the merging/splitting of clusters and moving data elements in and out of clusters; thereby a second context setting is created.

At 3005, progressively processing the web proxy log data to compute web proxy log analytics with respect to the clustering of the web proxy log data is restarted by the analytics modules.

At 3006, a second analytics interface responsive to the second context setting is generated by the context module.

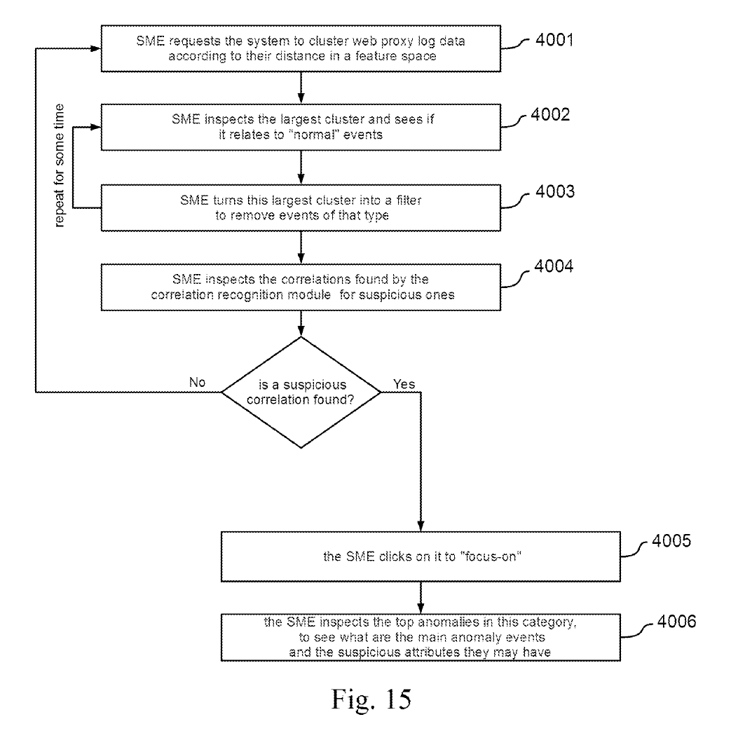

FIG. 15 is a flow chart illustrating exemplary activities of a subject matter expert when inspecting correlations after having applied a filter on the web proxy log data.

At 4001 the SME requests the system to cluster web proxy log data according to their distance in a feature space.

At 4002 the SME inspects the largest cluster and sees if it relates to “normal” events (e.g., “Protocol=HTTP”, “Port=80”, “HTTP Status=200”, “Request=None”, etc.)

At 4003 the SME turns this largest cluster into a filter to remove events of that type. In this way, large chunks of the data are rapidly discarded.

The SME repeats the activities at 4002 and 4003 for a number of times.

At 4004 the SME inspects the correlations found by the correlation recognition module for suspicious ones. If one is found (e.g., “Protocol=TOP”⇄“Port=80”).

If the SME does not find a suspicious correlation, the SME would, e.g. return to activity 4001 and request a different clustering of web proxy log data.

If the SME finds a suspicious correlation the SME clicks on it to “focus-on” at 4005.

At 4006 the SME inspects the top anomalies in this category, to see what are the main anomaly events and the suspicious attributes they may have.

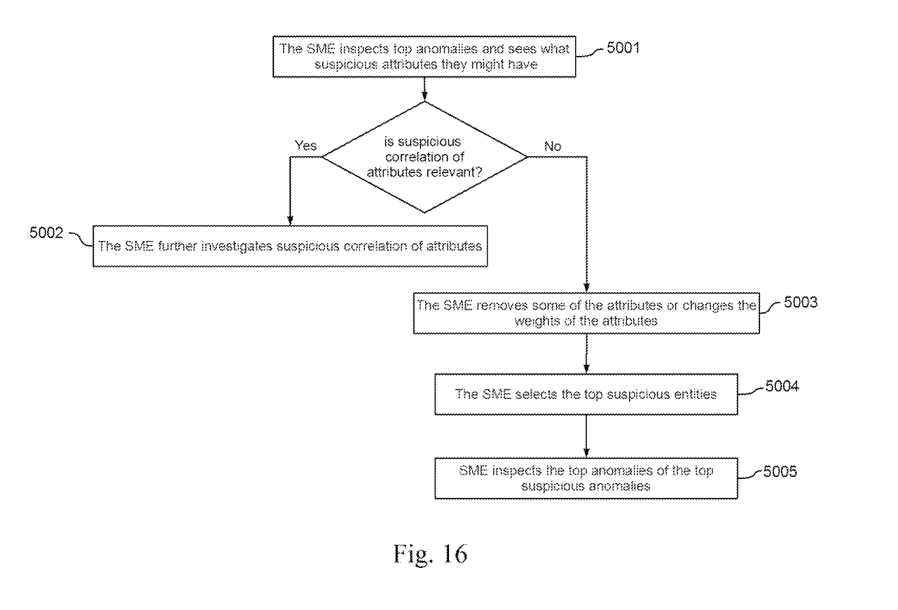

FIG. 16 is a flow chart illustrating exemplary activities of a subject matter expert when inspecting top anomalies.

At 5001, the SME inspects top anomalies and sees what suspicious attributes they might have. If the suspicious correlations of attributes is relevant, the SME further investigates the suspicious correlation of attributes at 5002.

If the suspicious correlations of attributes are not relevant, the SME removes some of the attributes or changes the weights of the attributes to train the system on what attributes are more or less important at 5003.

At 5004, the SME selects the top suspicious entities (e.g., sources addresses).

At 5005, the SME inspects their anomalies.

Examples of the disclosure provide a generalized system for interactive analytics interfaces based on context modifications. The generalized system automatically enables subject matter experts to explore and extract insights from their data without the need to engage in a complex information technology project. As described herein, an interactive platform runs a suite of algorithms in tandem aimed at data exploration to enable a user to steer the suite of algorithms, at the user's pace and preference.

The components of system 10 may be computing resources, each including a suitable combination of a physical computing device 900 (shown in FIG. 17), a virtual computing device, a network, software, a cloud infrastructure, a hybrid cloud infrastructure that may include a first cloud infrastructure and a second cloud infrastructure that is different from the first cloud infrastructure, and so forth. The components of system 10 may be a combination of hardware and programming for performing a designated visualization function. In some instances, each component may include a processor and a memory, while programming code is stored on that memory and executable by a processor to perform a designated function.

For example, the context module 7 may be a combination of hardware and programming to generate analytics interfaces 801, 802 based on respective context settings. Also, for example, the context module 7 may include software programming to identify and access an appropriate algorithm from the collection of analytics modules 6. The context module 7 may include hardware to physically store and/or maintain a dynamically updated database that stores the generated and/or paused analytics interfaces 801, 802.

Likewise, the interaction module 5 may be a combination of hardware and programming to provide the analytics interfaces 801, 802 to the computing device 900 (shown in FIG. 17) via the GUI 8. Also, for example, the interaction module 5 may include programming to identify a requested change in a context setting via an interaction with the GUI 8. The interaction module 5 may include hardware to physically store, for example, visualization features of the analytics interfaces. Also, for example, the interaction module 5 may include software programming to dynamically interact with the other components of system 10.

Generally, the components of system 10 may include programming and/or physical networks to be communicatively linked to other components of system 10, In some instances, the components of system 10 may include a processor and a memory, while programming code is stored and on that memory and executable by a processor to perform designated functions.

An exemplary computing device, as used herein, may be, for example, a web-based server, a local area network server, a cloud-based server, a notebook computer, a desktop computer, an all-in-one system, a tablet computing device, a mobile phone, an electronic book reader, or any other electronic device suitable for provisioning a computing resource to perform a unified visualization interface. The computing device may include a processor and a computer-readable storage medium.

FIG. 17 is a block diagram illustrating one example of a computer readable medium for interactive analytics interfaces based on context modifications. Processing system 900 includes a processor 902, a non-transitory computer readable medium, such as a memory 904, an alpha-numeric input device 905, and an I/O interface 909. Processor 902, non-transitory computer readable medium 904, input device 905, and I/O interface 909 are coupled to each other through a communication link (e.g., a bus) 901. Processor 902 executes instructions 910 included in the computer readable medium, such as memory 904. Non transitory computer readable medium 904 includes analytics module access instructions 910 to access, via the processor 902, a collection of analytics modules to generate a first analytics interface 801 (not shown in this Figure) based on a first context setting indicative of a plurality of parameters of web proxy log data.

The instructions 910 cause the processor 902 to provide the first analytics interface to a computing device via a video display 903, corresponding to the GUI 8 illustrated in other Figures.

Non transitory computer readable medium, such as memory 904 includes log data processing instructions to progressively processing web proxy log data by a plurality of analytics modules to compute web proxy log analytics for a first context setting.

Non transitory computer readable medium, such as memory 904 includes first analytics interface generating instruction to generate a first analytics interface based on the first context setting for displaying on a graphical user interface by a context module.

Non-transitory computer readable medium, such as memory 904 includes requested change identification instructions to identify a requested change in the first context setting via an interaction with the graphical user interface by an interaction module.

Non-transitory computer readable medium, such as memory 904 includes progressive processing pausing instructions to prompt the context module to pause the progressive processing of the web proxy log data and to pause the computing analytics for the first context setting in response to a requested change.

Non-transitory computer readable medium, such as memory 904 includes context modification instructions to modify the first context setting based on the requested change to create a second context setting by the context module.

Computer readable medium, such as memory 904 includes second interface generation instructions to generate a second analytics interface responsive to the second context setting by the context module.

Computer readable medium, such as memory 904 includes progressing restarting instructions to restart progressively processing the web proxy log data to compute web proxy log analytics for the second context setting upon creation of the second context setting by the context module.

Computer readable medium, such as memory 904 includes interface storing instructions to store the paused first analytics interface via the graphical user interface.

Input device 905 and additional I/O interface 909 include a keyboard, mouse, data ports, and/or other suitable devices for inputting information into processing system 900. In some examples these input devices are used to receive the requested changes to context settings. Video display 903 includes a monitor, speakers, data ports, and/or other suitable devices for outputting information from processing system 900. In some examples, the video display 903 is used to provide the analytics interfaces.

As used herein, a “non-transitory computer readable medium” may be any electronic, magnetic, optical, or other physical storage apparatus to contain or store information such as executable instructions, data, and the like. For example, any computer readable storage medium described herein may be any of flash memory, a storage drive (e.g., a hard drive), a solid state drive, and the like, or a combination thereof. For example, the computer readable medium 208 can include one of or multiple different forms of memory including erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

As described herein, various components of the processing system 900 are identified and refer to a combination of hardware and programming configured to perform a designated visualization function. As illustrated in FIG. 17, the programming may be processor executable instructions 910 stored on tangible computer readable medium, such as memory 904, and the hardware may include processor 902 for executing those instructions 910. Thus, non-transitory computer readable medium 904 may store program instructions that, when executed by processor 902, implement the various components of the processing system 900.

Such computer readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution. Non-transitory computer readable medium 904 may be any of a number of memory components capable of storing instructions that can be executed by processor 902. Non-transitory computer readable medium 904 may be non-transitory in the sense that it does not encompass a transitory signal but instead is made up of one or more memory components configured to store the relevant instructions. Non-transitory computer readable medium 904 may be implemented in a single device or distributed across devices, Likewise, processor 902 represents any number of processors capable of executing instructions stored by non-transitory computer readable medium, such as memory 904. Processor 902 may be integrated in a single device or distributed across devices. Further, computer readable medium, such as memory 904 may be fully or partially integrated in the same device as processor 902 (as illustrated), or it may be separate but accessible to that device and processor 902. In some examples, non-transitory computer readable medium 904 may be a machine-readable storage medium.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A system for interactive analysis of web proxy log data to detect malware, the system comprising:
a plurality of analytics modules to progressively process the web proxy log data to compute web proxy log analytics for a first context setting;
a context module to generate a first analytics interface based on the first context setting for displaying on a graphical user interface;
an interaction module to;
identify a requested change of the first context setting via an interaction with the graphical user interface,
prompt the context module to pause the progressive processing of the web proxy log data and to pause the computing analytics for the first context setting in response to the requested change; and wherein the context module is to
modify the first context setting based on the requested change to create a second context setting, and to
generate a second analytics interlace responsive to the second context setting
and wherein the plurality of analytics modules are to
restart progressively processing the web proxy log data to compute web proxy log analytics for the second context setting upon creation of the second context setting.

2. The system of claim 1, wherein the plurality of analytics modules comprises at least two of
an anomalous event recognition module to detect a number of anomalous events within the web proxy log data;
a value distribution calculation module to derive statistical distributions of attributes of the web proxy log data;
a correlation recognition module to detect a number of anomalous correlations within the web proxy log data;
a clustering module to cluster web proxy log data according to a distance in a feature space of the web proxy log data;
an entity-deviation calculation module to calculate and rank an entitydeviation between different entity statistical distributions within the web proxy log data,

3. The system of claim 1, wherein the interaction module is to identify a change of at least one weight of features of the web proxy log data in progressively computing analytics as the requested change of the first context setting and the context module is to modify the first context setting based on the change of the at least one weight in progressively computing analytics to create the second context setting.

4. The system of claim 1, wherein the plurality of analytics modules include a clustering module to duster the web proxy log data according to a distance in a feature space of the web proxy log data, and wherein the clustering module is to merge or split dusters and to move web proxy data elements in and out of a specific duster upon a corresponding requested change of the first context setting identified by the interaction module and modified by the context module,

5. The system of claim 1, wherein the plurality of analytics modules is to at least one of (i) remove and (ii) add attributes of the web proxy log data for processing the web proxy log data.

6. The system of claim 1, wherein the interaction module is to identify the creation or the change of at least one filter for removing events within the web proxy log data or focusing on specific types of events within the web proxy log data as a requested change of the first context setting, and the context module is to modify the context setting based on the creation or the change of the at least one filter.

7. The system of claim 1, wherein the interaction module is to identify the creation of categories of the web proxy log data as a requested change of the first context setting, the categories being filters focused on specific patterns in the web proxy log data to be tracked over time, and the context module is to modify the context setting based on the creation of the categories of the web proxy log data.

8. The system of claim 1, wherein the interaction module is to identify a selection of specific anomalies within the web proxy log data as a requested change of the first context setting, and the context module is to modify the context setting based on the selection of specific anomalies within the web proxy log data.

9. The system of claim 1, wherein the interaction module is to identify the selection of at least one of (i) a displayed cluster within the web proxy log data and (ii) a displayed correlation within the web proxy log data as a requested change of the first context setting, and wherein the context module is to modify the first context setting by turning at least one of (i) the selected cluster within the web proxy log data and (ii) the selected correlation within the web proxy log data into a respective filter and by applying the respective filter to the web proxy log data.

10. The system of claim 1, wherein the interaction module is to identify a selection of at least one of (i) entities of a computer network connected to the web proxy and (ii) distribution values of data attributes within the web proxy log data as the requested change of the first context setting, and wherein the context module is to modify the first context setting by turning at least one of the respective (i) entities and (ii) distribution values into a respective filter and by applying the respective filter to the web proxy log data.

11. The system of claim 1, further comprising a communication module connecting the system to a web proxy, wherein the communication module is to transmit a rule to the web proxy, the rule being created in response to identifying a pattern in the web proxy log data potentially caused by malware, the rule is to block network traffic according to the identified pattern.

12. A method of interactively analyzing web proxy log data for malware detection, the method comprising:
progressively processing the web proxy log data via a plurality of analytics modules to compute web proxy log analytics for a first context setting;
generating a first analytics interface based on the first context setting via a context module for displaying on a graphical user interface;
identifying a requested change of the first context setting via an interaction with the graphical user interface, via an interaction module;
pausing the progressive processing of the web proxy log data for the first context setting by the context module in response to the requested change;
modifying the first context setting based on the requested change by the context module to create a second context setting;
restart progressively processing the web proxy log data to compute web proxy log analytics for the second context setting by the plurality of analytics modules upon creation of the second context setting; and
generating a second analytics interface responsive to the second context setting by the context module.

13. The method of claim 12, wherein the interaction module identifies a change of at least one weight of features of the web proxy log data in progressively computing analytics for a first context setting, as a requested change of the first context setting and the context module modifies the first context setting based on the change of the at least one weight in progressively computing analytics to create the second context setting.

14. The method of claim 12, wherein progressively computing analytics for a first context setting comprises clustering web proxy log data according to a distance in a feature space of the web proxy log data and to merge or split clusters and to move web proxy data elements in and out of a specific cluster upon a corresponding requested change of the first context setting identified by the interaction module and modified by the context module.

15. A non-transitory computer readable medium comprising executable instructions to:
progressively process web proxy log data, via a plurality of analytics modules, to compute web proxy log analytics for a first context setting;
generate, via a context module, a first analytics interface based on the first context setting for displaying on a graphical user interface;
identify a requested change of the first context setting via an interaction ith the graphical user interface, via an interaction module;
prompt the context module to pause the progressive processing of the web proxy log data for the first context setting in response to the requested change;
store the first context setting and the first analytics interface on the non-transitory computer writeable medium to enable restoring the first context setting and the first analytics interface when requested;
modify, by the context module, the first context setting based on the requested change to create a second context setting;
restart progressively processing, via the plurality of analytics modules, the web proxy log data to compute web proxy log analytics for the second context setting upon creation of the second context setting; and
generate a second analytics interface responsive to the second context setting by the context module.
